(19) United States
(12) Patent Application Publication
(10) Pub. No.: US 2011/0096069 A1
(43) Pub. Date: Apr. 28, 2011

(54) DISPLAY OF TWO-DIMENSIONAL CONTENT DURING THREE-DIMENSIONAL PRESENTATION

(75) Inventor: William G. Redmann, Glendale, CA (US)

(73) Assignee: THOMSON LICENSING, Boulogne-Billancourt (FR)

(21) Appl. No.: 12/737,191

(22) PCT Filed: Jun. 19, 2008
(86) PCT No.: PCT/US2008/007644

§ 371 Date: Dec. 16, 2010

(51) Int. Cl. G06T 15/00

(52) U.S. Cl. 345/419

(57) ABSTRACT

A method of displaying non-stereoscopic images in three-dimensional moving presentations includes providing or receiving non-stereoscopic frames of two-dimensional images and stereoscopic frames of three-dimensional images and alternatingly displaying non-stereoscopic frames at least once to a left eye and at least once to a right eye. The method further includes setting and operating a display rate for the alternatingly displaying of the non-stereoscopic frames to a mean integer number of flashes per frame for the left eye and for the right eye or mean non-integer number of flashes per frame for the left eye and for the right eye such that the flashes are equal in duration and some flashes of a current frame are displayed into a following frame period.

### FIELD OF THE INVENTION

The invention relates to a projection system. In particular, the invention relates to presenting two-dimensional content during a three-dimensional presentation.

### BACKGROUND OF THE INVENTION

Three-dimensional (3D) theatrical presentations now typically include one or more ads or trailers running prior to the feature. These ads and trailers are generally made and displayed to be two-dimensional (2D) visual segments. As will be described in the following text, the prior art operation of the three-dimensional main feature and the two-dimensional ads or trailers each themselves have deficiencies in combination and individually.

Regarding three-dimensional presentations in general, it is well known that a projected image can be enhanced with an appearance of depth by converting the projected image into a so-called three-dimensional (3D) image. This is generally accomplished by optically polarizing the images which are to be viewed by a viewer's left eye differently than the images which are to be viewed by a viewer's right eye. The 3D effect is perceived by the viewer when the viewer views the polarized images through the use of polarized filter lenses, commonly configured as ‘3D viewing glasses’ with a polarized filter for use with the left eye of the viewer and a differently polarized filter for use with the right eye of the viewer. When the 3D viewing glasses are used to view the 3D images, the left eye of the viewer sees only the light polarized appropriately for passage through the polarized filter associated with the left eye and the right eye of the viewer sees only the light polarized appropriately for passage through the polarized filter associated with the right eye of the viewer. The above described method of displaying 3D images is known as passive 3D viewing where the projector alternates the left eye information with the right eye information at double the typical frame rate and a screen/filter/polarizing blocker in front of the projector's lenses alternates the polarization of the projected image in such a way that the image of each eye passes through the corresponding polarizing filter of the pair of passive stereo glasses discussed above. An alternative to passive 3D viewing is active 3D viewing where each viewer wears glasses with LCD light shutters which work in synchronization with the projector so that when the projector displays the left eye image, the right eye shutter of the active stereo eyewear is closed, and vice versa.

One problem with current systems for providing 3D images is a perceived “flicker” that is reported by some viewers of 3D images. Most generally, flicker is related to the human optical system perceiving an absence of viewable image for a first eye for the entire period the second eye is allowed to view an image. As time progresses, the second eye is prevented from viewing an image while the first eye views an image. The eyes are serially and alternatingly allowed to view images. The images viewed by the first and second eyes are of differing polarizations as described previously.

Prior Art FIG. 1 illustrates the timing of images shown to a viewer's left and right eyes using conventional systems for providing 3D images. Arrow 100 indicates a direction in which time is represented as increasing. Horizontal line 102 represents a time at which a first left eye image (hereinafter, “left eye image” is referred to as “LEI”) must be ready for projection to a viewer's left eye. LEI time period 104 (hereinafter, “LEI time period” is referred to as “LEITP”) represents the timing and duration of transfer of the first LEI (or first left eye frame) from an image generator (or image server) to a projector. Horizontal line 106 represents a time at which a second LEI must be ready for viewing by a viewer's left eye and LEITP 108 represents the timing and duration of transfer of the second LEI. Similarly, horizontal line 110 represents a time at which a third LEI must be ready for viewing by a viewer's left eye and LEITP 112 represents the timing and duration of transfer of the third LEI. In a conventional system for providing 3D images, delivery and availability for viewing of the LEIs and right eye images (hereinafter, “right eye image” is referred to as “REI”) are substantially synchronous such that they arrive to the projector from the generator and are available for projection at substantially the same time. This synchronized delivery is represented by first, second, and third REI time periods 114, 116, and 118, respectively, (hereinafter, “REI time period” is referred to as “REITP”) having substantially synchronized start and completion times to the start and completion times of LEITPs 104, 108, and 112, respectively. The gap in time between completion of delivery of the LEI and REI is generally referred to as slack in delivery 120 and typically corresponds to the time occupied by the projector actually making the images viewable.

The simplest conventional 3D image systems are single flash systems that alternate between a first LEI and first REI only once before progressing to the display of a second LEI and subsequent second REI. The timing of a single flash system 122 is represented by showing that a first LEI is flashed for a first LEI first duration 124 and followed by a first REI that is flashed for a first REI first duration 128. Next, a second LEI is flashed for a second LEI first duration 130 followed by a second REI being flashed for a second REI first duration 132. Finally, a third LEI is flashed for a third LEI first duration 134 followed by a third REI being flashed for a third REI first duration 136. As shown, a switching interval 126 occurs, where no image is shown to either eye, while switching between LEIs and REIs. However, this single flash system presents undesirable flicker.

To address the problem of flicker, double flash systems which alternate between LEIs and REIs twice before progressing to a second set of LEIs and REIs have been developed. The timing of a double flash system 138 is represented by showing that a first LEI is flashed for a first LEI first duration 140 followed by a first REI that is flashed for a first REI first duration 142. Next, the first LEI is again flashed for a first LEI second duration 144 followed by the first REI again being flashed for a first REI second duration 146. Next, a second LEI is flashed for a second LEI first duration 148 followed by a second REI being flashed for a second REI first duration 150. Next, the second LEI is again flashed for a second LEI second duration 152 followed by the second REI again being flashed for a second REI second duration 154. Next, a third LEI is flashed for a third LEI first duration 156 followed by a third REI being flashed for a third REI first duration 158. Finally, the third LEI is again flashed for a third LEI second duration 160 followed by the third REI being flashed for a third REI second duration 162. While the double flash system 138 is an improvement over the single flash system 122, this double flash system 138 still presents undesirable flicker perceived by some viewers.

A further attempt to reduce flicker has been made by providing a triple flash system that alternates three times between LEIS and REIs before progressing to subsequent sets of LEIS and REIs. The timing of a triple flash system 164 is represented by showing that images are flashed in the following order: first LEI first flash 166, first REI first flash 168, first LEI second flash 170, first REI second flash 172, first LEI third flash 174, first REI third flash 176, second LEI first flash 178, second REI first flash 180, second LEI second flash 182, second REI second flash 184, second LEI third flash 186, second REI third flash 188, third LEI first flash 190, third REI first flash 192, third LEI second flash 194, third REI second flash 196, third LEI third flash 198, and third REI third flash 200. Each flash is separated by a switching interval 126. While this triple flash system 164 further reduces flicker as compared to double flash system 138, not all conventional equipment is capable of accommodating the high speed switching between LEIs and REIs without reducing the overall resolution of the images.

While there are many advanced methods of displaying 3D images, room for improvement with regard to reducing flicker remains.

Regarding the two-dimensional (2D) visual segments in the form of ads or trailers, projectors in these 3D cinemas have displayed the ordinary 2D visual segments for which there are no distinct left-eye and right-eye images using the same mechanism employed for the three-dimensional main feature. This mechanism causes consecutive frames to be seen by alternate eyes. For example, all odd numbered frames are seen by one eye and all even numbered frames are seen by the other. This generally results in an intolerable flicker at 12 Hz per eye.

FIG. 2 illustrates the process and timing of the above-described alternating of non-stereoscopic frames between a viewer's left and right eyes. Arrow 100 indicates a direction in which time is represented as increasing. Horizontal line 202 represents a time at which a first non-stereoscopic frame is ready for projection to a viewer's left eye. First time period 204 represents the timing and duration of transfer of the first non-stereoscopic frame from an image generator (or image server) to a projector. Horizontal line 206 represents a time at which a second non-stereoscopic frame must be ready for viewing by viewer's right eye and second time period 208 represents the timing and duration of transfer of the a second non-stereoscopic frame. Similarly, horizontal line 210 represents a time at which a third non-stereoscopic frame is ready for viewing by a viewer's left eye. The timing of this single flash system is represented by showing that a first non-stereoscopic image (correlating to the first frame) is flashed for a first duration 224 to the left eye and followed by a second non-stereoscopic image (correlating to the second frame) is flashed for a second duration 230 to the right eye, wherein the individual flashes are separated in time by switching interval 226. It then follows that a third non-stereoscopic image (correlating to the third frame) is flashed for a third duration 234 to the left eye. As mentioned above, for this example in FIG. 2, with the frame rate being 24 Hz, each eye will experience a 12 Hz rate, thereby causing the viewer to experience undesirable flicker. As such, a need exists for a method of displaying non-stereoscopic images during three-dimensional presentations that does not cause the viewer to experience undesirable flicker.

### SUMMARY OF THE INVENTION

A method for displaying a single production of a three-dimensional presentation which includes two-dimensional content comprises detecting the two-dimensional content and selecting flash rates above human flicker threshold for the two-dimensional content; displaying a first single frame of a first non-stereoscopic image at least once to right eyes and at least once to left eyes at the flash rates; displaying a second single frame of a second non-stereoscopic image at least once to right eyes and at least once to left eyes at the flash rates; and displaying a third single frame of a third non-stereoscopic image at least once to right eyes and at least once to left eyes at the flash rates. The method further comprises detecting a three-dimensional content and selecting other flash rates above human flicker threshold for the three-dimensional content and displaying the three-dimensional content at the other flash rates. Displaying three-dimensional images of the three-dimensional content can comprise of displaying a first image having a first polarization for one eye of a viewer, displaying a first image having a second polarization for the other eye of a viewer and alternately repeating these displaying steps until each of the displaying steps has been performed at least twice and until one of the displaying steps has been performed more times than the other of the displaying steps. The method can further comprise displaying a second image having the first polarization for the one eye of the viewer, displaying a second image having the second polarization for the other eye of the viewer, and alternately repeating the displaying steps for the second image until each of these displaying steps has been performed at least twice and until one of these displaying steps has been performed more times than the other of the displaying steps.

### BRIEF DESCRIPTION OF THE DRAWINGS

Prior Art FIG. 1 is a schematic illustration of conventional single, double, and triple flash systems for displaying three-dimensional images according to the prior art.

FIG. 2 is a schematic illustration of a flash system for displaying two-dimensional images in a conventional three-dimensional theatrical presentations according to the prior art.

FIG. 3 is a schematic illustration of a 3D projection system according to the present invention.

FIG. 4 is a schematic illustration of an alternating dominance non-integer timing scheme according to the present invention.

FIG. 5 is a schematic illustration of a ready dominance non-integer timing scheme according to the present invention.

### DETAILED DESCRIPTION OF THE INVENTION

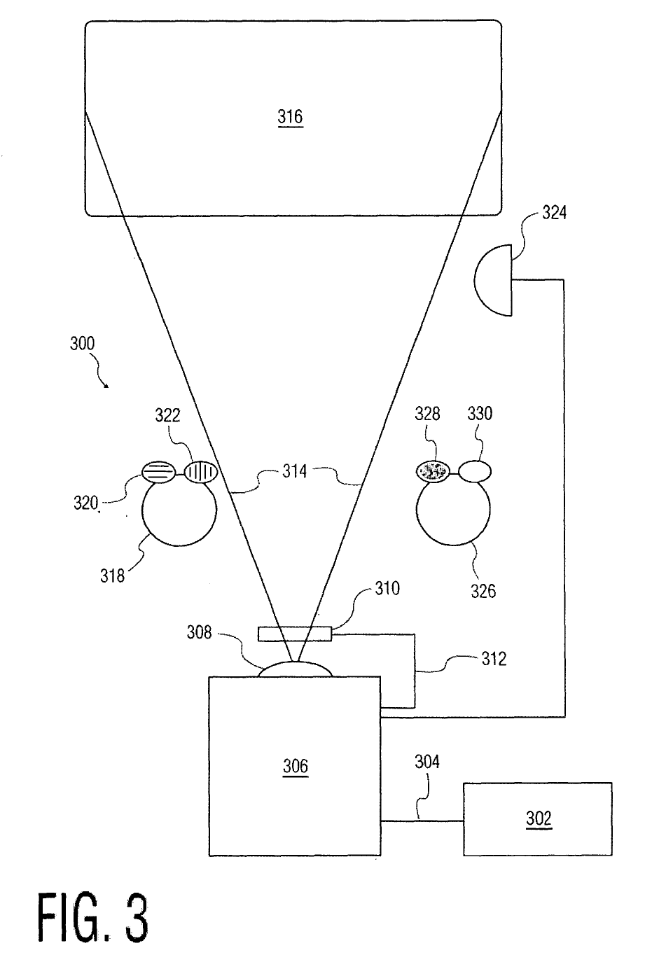

Referring now to FIG. 3 in the drawings, a 3D projection system which displays three-dimensional content and two-dimensional content according to the present invention is illustrated 3D projection system 300 comprises an image source 302 (or image server) for providing LEIs and REIs over an image link 304 (which can be an encrypted, dual high definition serial digital interface (HD-SDI)) to a digital projector 306. The LEIs and REIs are projected from the projector 306 through a projection lens 308 and subsequently through a polarizing cell and driver 310 which supplies a polarizing phase signal 312 from the projector 306. After passing through the polarizing cell and driver 310, the LEIs and REIs are directed as a projection 314 onto a screen 316. A viewer 318 is enabled to perceive the 3D image using a left eye polarized lens 320 and a right eye polarized lens 322. In operation, as a LEI is transmitted through the polarizing cell and driver 310, the LEI is polarized in a first polarization scheme. The polarized LEI is reflected from the screen 316 to the viewer 318 through left eye polarized lens 320. Similarly, as a REI is transmitted through the polarizing cell and driver 310, the REI is polarized in a second polarization scheme. The polarized REI is reflected from the screen 316 to the viewer 318 through right eye polarized lens 322. It will be appreciated that the polarization schemes can include the use of P-polarization/S-Polarization or clockwise circular polarization/counter-clockwise circular polarization. This embodiment requires that the screen 316 preserves the polarization of projection 314 as the projection is reflected from the screen 316 to the viewer 318.

In an alternative embodiment, the 3D projection system 300 can comprise an infrared emitter 324 for use with active shutter glasses worn by a user 326. The active shutter glasses comprise a left eye active shutter 328 and a right eye active shutter 330. The active shutter glasses include a receiver (not shown) for receiving a signal from the infrared emitter 324 (or transmitter). The signal provided to the active shutter glasses synchronizes the left and right eye active shutters 328 and 330 with the LEIs and REIs provided by the projector 306 so that the left eye active shutter 328 allows viewing when a LEI is displayed by the projector and so that the right eye active shutter 330 does not allow viewing when a LEI is displayed by the projector. Similarly, the right eye active shutter 330 allows viewing when a REI is displayed by the projector and the left eye active shutter 328 does not allow viewing when a REI is displayed by the projector 306. Where an infrared emitter 324, left eye active shutter 328, and right eye active shutter 330 are used to allow viewing of a 3D image, the 3D projection system 300 would not need to employ the polarizing cell and driver 310, left eye polarized lens 320, or right eye polarized lens 322, nor would screen 316 be required to preserve polarization of projection 314.

Another alternative embodiment of 3D projection system 300 can comprise mutually exclusive narrow band RGB color comb filters for allowing only LEIs through a left color comb filter (not shown) and REIs through a right color comb filter (not shown). In this embodiment, the LEIs and REIs are projected from the projector 306 having color components suitable for filtering by the color comb filters.

The 3D projection system 300 is suitable for providing LEIs and REIs to the viewer's left and right eyes, respectively, at various rates and with various timing schemes (discussed infra).

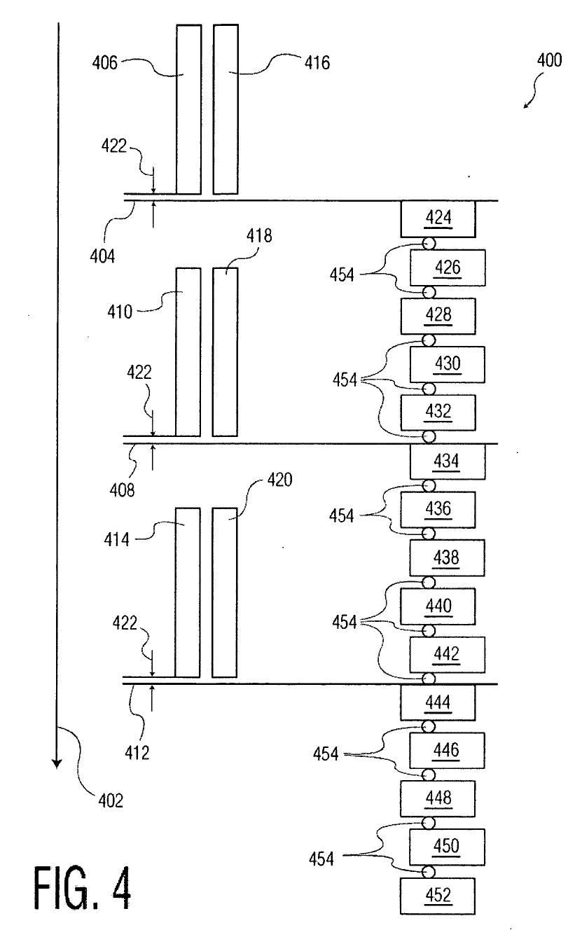

Referring now to FIG. 4 in the drawings, FIG. 4 illustrates an alternating dominance non-integer timing scheme 400 according to the present invention. Alternating dominance non-integer timing scheme 400 is suitable for use with 3D projection system 300 in providing LEIs and REIs to a viewer's left and right eyes, respectively. Arrow 402 indicates a direction in which time is represented as increasing. Horizontal line 404 represents a time at which a first LEI must be ready for projection to a viewer's left eye. LEITP 406 represents the timing and duration of transfer of the first LEI (or first left eye frame) from an image generator (or image server) to a projector. In this scheme for providing 3D images, delivery and availability for viewing of the LEIs and REIs are substantially synchronous such that they arrive to the projector from the generator and are available for projection at substantially the same time. This synchronized delivery is represented by first, second, and third REITPs 416, 418, and 420, respectively, having substantially synchronized start and completion times to the start and completion times of LEITPs 406, 410, and 414, respectively. The gaps in time between completion of delivery of the LEIs and the times at which LEIs must be ready for projection are generally referred to as slack in delivery 422 which typically correspond to the time occupied by the projector actually making the images viewable The slack in delivery 422, which could otherwise be referred to as setup time, is illustrated as being short relative to the frame time. This is appropriate to the clarity of the illustration, and fundamentally communicates a deadline by which the next frame must arrive. However, in cases where a projector implementation uses a frame-buffered pipeline architecture, the actual setup time pointed out by delivery 422 can be on the order of magnitude of several frames.

Still referring to FIG. 4, alternating dominance non-integer timing scheme 400, in this embodiment, alternates between LEIs and REIs 2.5 times before progressing to a second set of LEIs and REIs. The timing of this alternating dominance non-integer timing scheme 400 is represented by showing that a first LEI is flashed for a first LEI first duration 424 followed by a first REI that is flashed for a first REI first duration 426. Next, the first LEI is again flashed for a first LEI second duration 428 followed by the first REI again being flashed for a first REI second duration 430. Next, the first LEI is flashed for a first LEI third duration 432 which is not followed by any subsequent flashes of the first REI.

Still referring to FIG. 4, the scheme 400 progresses to displaying a second set of LEIs and REIs. Particularly, horizontal line 408 represents a time at which a second REI must be ready for viewing by a viewer's right eye and LEITP 410 represents the timing and duration of transfer of the second LEI. With this second set of LEIs and REIs, the REI is first to be displayed rather than the LEI. Specifically, a second REI is flashed for a second REI first duration 434 followed by a second LEI being flashed for a second LEI first duration 436. Next, the second REI is again flashed for a second REI second duration 438 followed by the second LEI again being flashed for a second LEI second duration 440. Next, the second REI is flashed for a second REI third duration 442 which is not followed by any subsequent flashes of the second LEI. Instead, the scheme 400 progresses to displaying a third set of LEIs and REIs.

Still referring to FIG. 4, the scheme 400 progresses to displaying a third set of LEIs and REIs. Similarly, horizontal line 412 represents a time at which a third LEI must be ready for viewing by a viewer's left eye and LEITP 414 represents the timing and duration of transfer of the third LEI. As with the first set of LEIs and REIs, in this third set of LEIs and REIs, the LEI is first to be displayed rather than the REI. Finally, a third LEI is flashed for a third LEI first duration 444 followed by a third REI being flashed for a third REI first duration 446 followed by the third LEI again being flashed for a third LEI second duration 448. Next, the third REI is again flashed for a third REI second duration 450. Next, the third LEI is flashed for a third LEI third duration 452 which is not followed by any subsequent flashes of the third REI. Instead, the scheme 400 progresses to displaying a fourth and subsequent sets (not shown) of LEIs and REIs in this manner. A switching interval 454, a time during which no image is shown to either eye, occurs between each alternating display of LEIs and REIs and is useful in minimizing undesirable optical perception of crosstalk between the LEIs and REIs due to switching times of polarization cell and drivers 310, which can be encoder cells, or shutters 328 and 330, which can be active lenses. The non-integer timing scheme provides for a decrease in perceived flicker by way of the increased number of times each LEI and REI are shown without exceeding bandwidth limitations of many conventional projectors. Since the bandwidth limitations of the equipment is not exceeded, the LEIs and REIs can be transmitted in their full resolution as intended by the producer of the image.

Although the above embodiment has the start and completion times of REITPs 416, 418, and 420 synchronized with the start and completion times of LEITPs 406, 410, and 414, other embodiments of the invention include the REITPs 416, 418, and 420 not being synchronized with the start and completion times of LEITPs 406, 410, and 414 such that the start times and/or completions of the REITPs 416, 418, and 420 for a frame can be respectively before or after those of the LEITPs 406, 410, and 414, or in other words, the REITPs or LEITPs are shifted respect to the other.

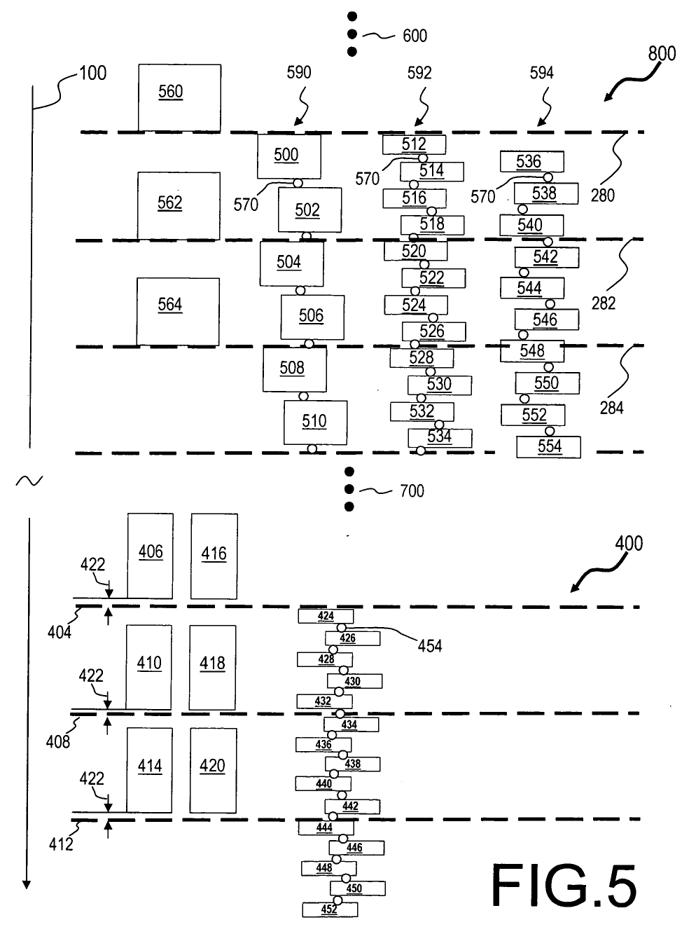

FIG. 5 illustrates a display of two-dimensional content scheme systems 800 in a three-dimensional production, wherein an alternating dominance non-integer timing scheme 400 for three-dimensional viewing is shown. In general, a three-dimension production according to the invention will include the two-dimensional content and three-dimensional content being continuous with each other. Although an alternating dominance non-integer timing scheme 400 is shown for the three-dimensional content, the invention includes embodiments where other three-dimensional schemes such as an equal single flash scheme (such as the single flash system 122), a three-dimensional equal double flash scheme (such as the double flash system 138), or a three-dimensional equal triple flash scheme (such as triple flash system 164) are used with any of the two-dimensional content schemes which include the phase-locked double flash scheme 590, the phase-locked quadruple flash scheme 592, or the free run flash scheme 594.

A further description of the an alternating dominance non-integer timing scheme 400 shown in FIG. 5 will be omitted, because the features of this scheme have already been described with reference to FIG. 4.

Regarding FIG. 5, exemplary three-dimensional productions are shown wherein different two-dimensional content schemes 590, 592 and 594 are utilized in the production before a three-dimensional alternating dominance non-integer timing scheme 400, wherein a first and second transitional detection periods 600 and 700 are shown. The first transitional detection period 600 is a process step in which the display equipment essentially detects the initiation or transition to two-dimensional content and triggers the display equipment to begin displaying the two-dimensional content according to the preferred two-dimensional flashing scheme. The second transitional detection period 700 is a process step in which the display equipment essentially detects the transition between two-dimensional content and three-dimensional content and essentially triggers display equipment to begin displaying the three-dimension content according to the preferred three-dimensional flashing scheme. Although FIG. 5 shows one clip of two-dimensional content before one clip of three-dimensional content, three-dimensional content can precede two-dimensional content and there can be a plurality of alternating content schemes.

The first two-dimensional content scheme shown in FIG. 5 is the phase-locked double flash scheme 590. Arrow 100 indicates a direction in which time is represented as increasing. Horizontal line 280 represents a time at which a first non-stereoscopic image of the first two-dimensional frame must be ready for projection to a viewer's left eye. First time period 560 represents the timing and duration of transfer of the first non-stereoscopic frame from an image generator (or image server) to a projector. Likewise horizontal lines 282, 284 represent times at which a second and third non-stereoscopic frames, respectively, must be ready for viewing by a viewer's left eye. Second and third time periods 562, 564 represent the timing and duration of transfer of the second and third non-stereoscopic frames. The timing of this double flash system is represented by showing that a first non-stereoscopic image (correlating to the first frame) is flashed for a left first duration 500 to the left eye followed by the first non-stereoscopic image (correlating to the first frame) being flashed for a right first duration 502 to the right eye, wherein switching intervals 570 are shown separating the individual flashes between the left and right eyes. If two consecutive flashes are of the same image, there may be no need for a blanking interval imposed by the projector between the flashes. However, switching intervals 570 can still represent the switching time of the encoder cell 310 or the active lenses 328 and 330. Next, a second non-stereoscopic image (correlating to the second frame) is flashed for a second left first duration 504 to the left eye followed by the second non-stereoscopic image (correlating to the first frame) being flashed for a second right first duration 506 to the right eye. Then, a third non-stereoscopic image (correlating to the third frame) is flashed for a third left first duration 508 to the left eye followed by the third non-stereoscopic image (correlating to the third frame) being flashed for a third right first duration 510 to the right eye.

The second two-dimensional content scheme shown in FIG. 5 is the phase-locked quadruple flash scheme 592. Arrow 100 indicates a direction in which time is represented as increasing. The first, second, and third time periods 560, 562, 564 again represent the timing and duration of transfer of the respective non-stereoscopic frames from an image generator (or image server) to a projector. Likewise horizontal lines 280, 282, 284 represent times at which the respective non-stereoscopic frames must be ready for viewing by viewer's left eye and the respective time periods 560, 562, 564 represent the timing and duration of transfer of respective non-stereoscopic frames. The timing of this quadruple flash system is represented by showing that a first non-stereoscopic image (correlating to the first frame) is flashed for a left first frame duration 512 to the left eye followed by the first non-stereoscopic image (correlating to the first frame) being flashed for a right first frame duration 514 to the right eye. It then follows that the first non-stereoscopic image is flashed to a second left first frame duration 516 to the left eye followed by the first non-stereoscopic image being flashed for a second left first frame duration 518 to the right eye. Next, a second non-stereoscopic image (correlating to the second frame) is flashed for a first left second frame duration 520 to the left eye followed by the first non-stereoscopic image (correlating to the second frame) being flashed for a first right second frame duration 522 to the right eye. It then follows that the second non-stereoscopic image is flashed to a second left second frame duration 524 to the left eye followed by the first non-stereoscopic image being flashed for a second left second frame duration 526 to the right eye. As shown FIG. 5, the quadruple flash sequence for the third non-stereoscopic frame is shown where the flashes proceed as follows: first left third frame duration 528, first right third frame duration 530, second left third frame duration 532, and second right third frame duration 534. Although each of the sequences shown specifically refer to flashing to left first, it should be understood that the invention include embodiments where the sequences begin with flashing to right eyes first.

The third two-dimensional content scheme shown in FIG. 5 is the free-run scheme 594. Arrow 100 indicates a direction in which time is represented as increasing. The first, second, and third time periods 560, 562, 564 again represent the timing and duration of transfer of the respective non-stereoscopic frames from an image generator (or image server) to a projector. Likewise horizontal lines 280, 282, 284 represent times at which the respective non-stereoscopic frames is ready for viewing by the viewer's eye that is ready to accept and show an entire frame duration, wherein an entire frame duration is a time period selected for a single flash. The timing of the free run scheme is represented by showing that a first non-stereoscopic image (correlating to the first frame) is flashed for a left first frame duration 536 to the left eye followed by the first non-stereoscopic image (correlating to the first frame) being flashed for a right first frame duration 538 to the right eye. It then follows that the first non-stereoscopic image is flashed for a second left first frame duration 540 to the left eye. Next, because the second frame is ready for presentation to the viewer's right eye and it is the right eye's turn to accept flashing, a second non-stereoscopic image (correlating to the second frame) is flashed for a first right second frame duration 542 to the right eye followed by the second non-stereoscopic image (correlating to the second frame) being flashed for a first left second frame duration 544 to the left eye. It then follows that the second non-stereoscopic image is flashed again for a second right second frame duration 546 to the right eye. Now because the viewer's left eye is ready to accept a flash and the third time period 564 is not yet complete, the second non-stereoscopic image (correlating to the second frame) is flashed for a second left second frame duration 548 to the left eye. However, the invention with regard to the free-run scheme 594 allows the flashing during the second left second frame duration 548 to the left eye to extend beyond the point in time (i.e. horizontal line 284) designated for flashing of the third respective non-stereoscopic image frame. In other words, the display rate for the free-run scheme is a mean non-integer flash rate where complete flashes (i.e. frame durations) to a specific eye initiated during a specific frame period can extend to a subsequent frame period until the given flash completely ends. Frame periods are the blocks of time established by the frame rate of the production and demarcated by the horizontal lines 280, 282, 284. With the third non-stereoscopic image (correlating to the third frame) and the viewer right eye being ready for flashing, the third non-stereoscopic image is flashed for a first right third frame duration 550. Next, the third non-stereoscopic image is flashed for a first left third frame duration 552 to the left eye followed by third non-stereoscopic image being flashed for a second right third frame duration 554. The method can further be characterized in that for at least two consecutive frames for the display of two-dimensional content, the sum of the number of times the left eye is flashed for one non-stereoscopic image frame and the number of times the right eye is flashed for the one non-stereoscopic image frame is not equal to the sum of the number of times the left eye is flashed for a next non-stereoscopic image frame and the number of times the right eye is flashed for the next non-stereoscopic image frame.

It should be pointed out that a feature of the invention can be that there is no overlap time of the displaying the non-stereoscopic images to the right and left eyes for the free run embodiments, as well as the phase-locked embodiments, which is implies that there can be switching intervals. Further, it should be pointed out that a feature of the invention can be that the time durations of the flashes are equal for the two-dimension embodiments.

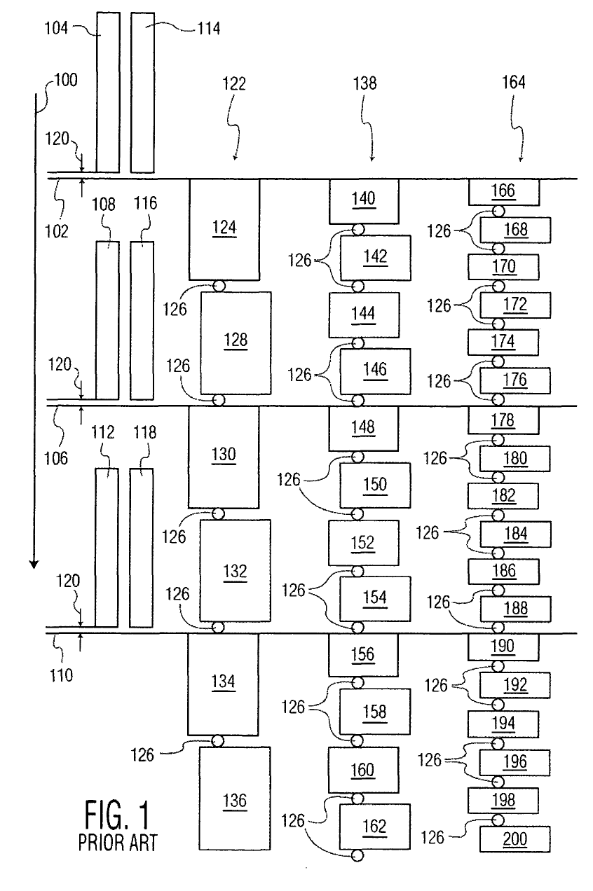

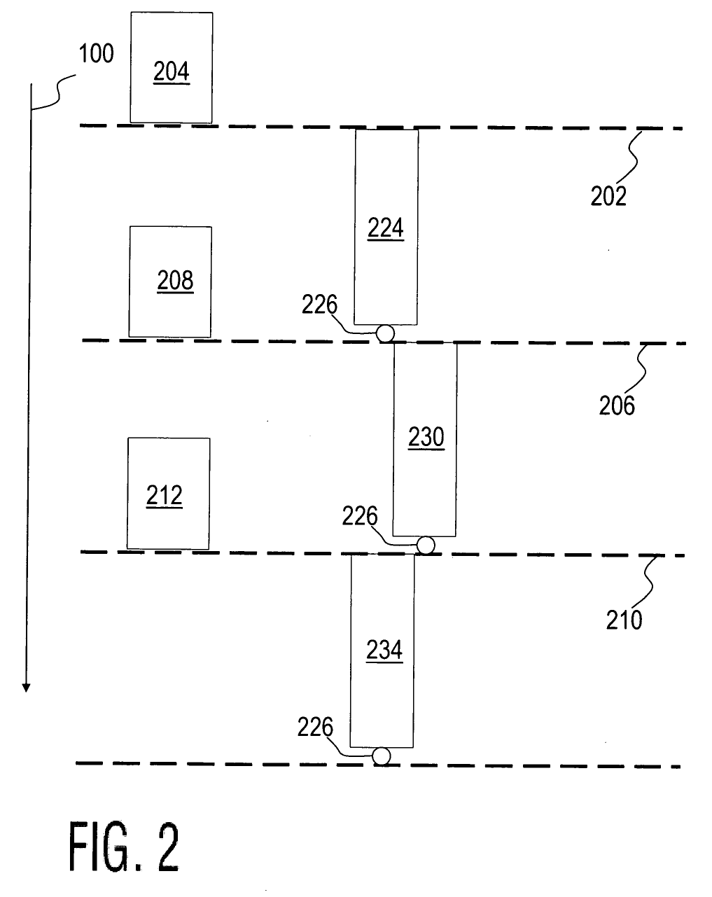

As mentioned above, in the example of the two-dimensional content scheme shown in FIG. 2 during a three-dimensional production having a frame rate being 24 Hz, each eye will experience a 12 Hz rate, thereby causing the viewer to experience undesirable flicker.

However, the embodiments shown in FIG. 5 solve this problem, because the two-dimensional content scheme systems 800 can have flash rates per eye exceeding the rates where flicker can perceived. For example, for phase-locked double flash scheme 590 when the frame rate is 24 Hz, the flash rate per eye will be 24 Hz. For the phase-locked quadruple flash scheme 592, when the frame rate is 24 Hz, the flash rate per eye will be 48 Hz. The phase-locked quadruple flash scheme 592 is superior to the phase-locked double flash scheme 590 in terms of flicker suppression, because it better ensures that individuals with greater flicker sensitivity will not perceive flicker. However, from a bandwidth limitations perspective of conventional projectors, the phase-locked quadruple flash scheme 592 is less attractive than the phase-locked double flash scheme 590. As such, the implementation of free run flash scheme 594 (which is essentially a non-integer flash rate) in three-dimensional production can serve a best mode of operating the two-dimensional content, because it can provide flash rates greater than those of the phase-locked double flash scheme 590 to help avoid flicker, but yet be less burdensome on bandwidth than the phase-locked quadruple flash scheme 592.

Furthermore, free run flash scheme 594 in combination with an alternating dominance non-integer timing scheme 400 can solve the problem of the possibility of flicker being observed by the most sensitive observer for both the two and three-dimensional scenes while reducing the burden of bandwidth for both the two and three-dimensional content.

A presently preferred embodiment of the invention can be characterized as a method of displaying a 3D image that comprises the steps of: non-synchronously providing a first left eye image and a first right eye image for display; alternatingly displaying the first left eye image and the first right eye image at a substantially fixed rate, beginning with the first of first left eye image and the first right eye image to be fully provided; non-synchronously providing a second left eye image and a second right eye image for display; and substituting display of the first left eye image with the second left eye image when the second left eye image is fully provided and substituting display of the first right eye image with the second right eye image when the second right eye image is fully provided. In the method, the first left eye image is fully provided before the first right eye image or the first right eye image is fully provided before the first left eye image. The method can further be characterized in that the sum of the number of times the first left eye image is displayed and the number of times the first right eye image is displayed is not equal to the sum of the number of times the second left eye image is displayed and the number of times the second right eye image is displayed. Alternatively, the method can be characterized in that the first left eye image and the first right eye image are provided serially with respect to each other and the second left eye image and the second right eye image are provided serially and subsequent to the first left eye image and the first right eye image.

Another presently preferred embodiment of the invention can be characterized as a method of displaying three-dimensional images that comprises: displaying a first image having a first polarization for one eye of a viewer; displaying a first image having a second polarization for the other eye of a viewer; and alternately repeating the displaying steps until one of the displaying steps has been performed more times than the other of the displaying steps. The method can further comprise alternately repeating the displaying steps until each of the displaying steps has been performed at least twice.

Another embodiment of the invention is a method including the steps of receiving or providing non-stereoscopic frames of two-dimensional images and stereoscopic frames of three-dimensional images; displaying the stereoscopic frames as a three-dimensional moving image presentation, using a first flash per eye per frame; and displaying the two-dimensional images responsive to the non-stereoscopic frames, instead of displaying the three-dimensional moving image presentation, using a second flash per eye per frame. This method can include selectively initiating the second displaying step before, during or after initiating the first displaying step. The method can further include alternatingly displaying non-stereoscopic frames at least once to a left eye and at least once to a right eye. Also, the method can include detecting the non-stereoscopic frames and setting and operating a display rate for the alternatingly displaying of the non-stereoscopic frames to a mean non-integer number of flashes per frame for the left eye and for the right eye. The method can also comprise detecting the non-stereoscopic frames and setting a display rate for the alternatingly displaying of the non-stereoscopic frames to a non-integer number of flashes per frame for the left eye and the right eye, wherein the flashes are equal in duration such that some flashes of a current frame are displayed into a following frame period.

The foregoing illustrates only some of the possibilities for practicing the invention. Many other embodiments are possible within the scope and spirit of the invention. For example, although the examples generally show cases of three consecutive frames, embodiments include examples other numbers of consecutive frames. It is, therefore, intended that the foregoing description be regarded as illustrative rather than limiting, and that the scope of the invention is given by the appended claims together with their full range of equivalents.

1. A method, comprising the steps of:
displaying stereoscopic frames as a three-dimensional moving image presentation using a first flash per eye per frame and
displaying two-dimensional images responsive to non-stereoscopic frames, instead of displaying said three-dimensional moving image presentation, using a second flash per eye per frame.

2. The method of claim 1, comprising the step of selectively initiating said second displaying step before, during or after initiating said first displaying step.

3. The method of claim 2, comprising the step of alternatingly displaying non-stereoscopic frames at least once to a left eye and at least once to a right eye.

4. The method of claim 1, further comprising the steps of:
detecting the non-stereoscopic frames; and
setting and operating a display rate for the alternatingly displaying of the non-stereoscopic frames to a mean non-integer number of flashes per frame for the left eye and for the right eye.

5. The method of claim 1, further comprising the steps of:
detecting the non-stereoscopic frames; and
setting a display rate for the alternatingly displaying of the non-stereoscopic frames to a non-integer number of flashes per frame for the left eye and the right eye, wherein the flashes are equal in duration such that some flashes of a current frame are displayed into a following frame period.

6. A method comprising the steps of:
receiving non-stereoscopic frames of two-dimensional images for displaying non-stereoscopic images;
receiving stereoscopic frames of three-dimensional images for displaying stereoscopic images in a three-dimensional moving presentation; and
alternatingly displaying non-stereoscopic frames at least once to a left eye and at least once to a right eye.

7. The method of claim 6, further comprising the steps of:
detecting the non-stereoscopic frames;
setting a display rate for the alternatingly displaying of the non-stereoscopic frames to one flash per frame for the left eye and one flash for the right eye.

8. The method of claim 6, further comprising the steps of:
detecting the non-stereoscopic frames;
setting a display rate for the alternatingly displaying of the non-stereoscopic frames to two flashes per frame for the left eye and two flashes for the right eye.

9. The method of claim 6, further comprising the steps of:
detecting the non-stereoscopic frames;
setting and operating a display rate for the alternatingly displaying of the non-stereoscopic frames to a mean non-integer number of flashes per frame for the left eye and for the right eye.

10. The method of claim 6, further comprising the steps of:
detecting the non-stereoscopic frames; and
setting a display rate for the alternatingly displaying of the non-stereoscopic frames to a non-integer number of flashes per frame for the left eye and the right eye, wherein the flashes are equal in duration such that some flashes of a current frame are displayed into a following frame period.

11. The method of claim 6, further comprising the steps of:
detecting the stereoscopic frames of three-dimensional images; and
alternatingly displaying left eye images and right eye images of for the stereoscopic frames, wherein the left eye images and the right eye images are displayed an equal number of times in respective frame periods.

12. The method of claim 8, further comprising the steps of:
detecting stereoscopic frames of three-dimensional images; and
alternatingly displaying left eye images and right eye images of for the stereoscopic frames, wherein the left eye images and the right eye images are displayed an equal number of times in respective frame periods.

13. The method of claim 9, further comprising the steps of:
detecting stereoscopic frames of three-dimensional images; and
alternatingly displaying left eye images and right eye images of for the stereoscopic frames, wherein the left eye images and the right eye images are displayed an equal number of times in respective frame periods.

14. The method of claim 10, further comprising the steps of:
detecting stereoscopic frames of three-dimensional images; and
alternatingly displaying left eye images and right eye images of for the stereoscopic frames, wherein the left eye images and the right eye images are displayed an equal number of times in respective frame periods.

15. The method of claim 6, further comprising the steps of:
detecting stereoscopic frames of three-dimensional images; and
alternatingly displaying left eye images and right eye images of for the stereoscopic frames, wherein the left eye images and the right eye images are displayed an unequal number of times in respective frame periods such that in a given stereoscopic frame a first left eye image displays one more than a first right eye image and in a next stereoscopic frame a second right eye image displays one more than a second left eye image.

16. The method of claim 8, further comprising the steps of:
detecting stereoscopic frames of three-dimensional images; and
alternatingly displaying left eye images and right eye images of for the stereoscopic frames, wherein the left eye images and the right eye images are displayed an unequal number of times in respective frame periods such that in a given stereoscopic frame a first left eye image displays one more than a first right eye image and in a next stereoscopic frame a second right eye image displays one more than a second left eye image.

17. The method of claim 9, further comprising the steps of:
detecting stereoscopic frames of three-dimensional images; and
alternatingly displaying left eye images and right eye images of for the stereoscopic frames, wherein the left eye images and the right eye images are displayed an unequal number of times in respective frame periods such that in a given stereoscopic frame a first left eye image displays one more than a first right eye image and in a next stereoscopic frame a second right eye image displays one more than a second left eye image.

18. The method of claim 10, further comprising the steps of:
detecting stereoscopic frames of three-dimensional images; and
alternatingly displaying left eye images and right eye images of for the stereoscopic frames, wherein the left eye images and the right eye images are displayed an unequal number of times in respective frame periods such that in a given stereoscopic frame a first left eye image displays one more than a first right eye image and in a next stereoscopic frame a second right eye image displays one more than a second left eye image.
